(19) United States
(12) Patent Application Publication
(10) Pub. No.: US 2018/0056316 A1
(43) Pub. Date: Mar. 1, 2018

(54) Irrigation Head Pad

(71) Applicant: Donna Biscardi, The Villages, FL (US)

(72) Inventor: Donna Biscardi, The Villages, FL (US)

(21) Appl. No.: 15/688,070

(22) Filed: Aug. 28, 2017

Related U.S. Application Data
(60) Provisional application No. 62/380,630, filed on Aug. 29, 2016.

(51) Int. Cl. B05B 15/00

(52) U.S. Cl. CPC B05B 15/001

(57) ABSTRACT

An irrigation head pad. The irrigation head pad includes a planar member having an aperture disposed thereon, wherein an edge of the planar member is linear. A plurality of concentric circular members are configured to removably secure within one another. The aperture is configured to removably secure the plurality of concentric circular members therein. The diameter of the aperture can be adjusted via removing subsequent concentric circular members, such that varying sizes of sprinkler heads can be inserted through the aperture. In this way, the area surrounding the sprinkler head is covered by the planar member, preventing fouling of the sprinkler head.

### CROSS REFERENCE TO RELATED APPLICATIONS

This application claims the benefit of U.S. Provisional Application No. 62/380,630 filed on Aug. 29, 2016. The above identified patent application is herein incorporated by reference in its entirety to provide continuity of disclosure.

### BACKGROUND OF THE INVENTION

The present invention relates to irrigation pads. Specifically, it relates to pads having an aperture configured to receive an irrigation head therethrough.

Many people use sprinklers to water their lawns or gardens, however the area surrounding the sprinkler head can be difficult to keep clear of leaves, weeds, and other debris that could interfere with the operation of the sprinkler. Frequently, the caretakers spend a large amount of time maintaining the area around a sprinkler by manually removing debris to ensure the sprinkler operates efficiently. A more efficient method of maintaining the area around a sprinkler head is required. Therefore, a pad having an aperture configured to receive a sprinkler head therethrough is provided.

In light of the devices disclosed in the known art, it is submitted that the present invention substantially diverges in design elements from the known art and consequently it is clear that there is a need in the art for an improvement to existing irrigation pads. In this regard, the instant invention substantially fulfills these needs.

### SUMMARY OF THE INVENTION

In view of the foregoing disadvantages inherent in the known types of irrigation pads now present in the prior art, the present invention provides an irrigation pad wherein the same can be utilized for providing convenience for the user when operating a lawn sprinkler system.

The present system comprises a planar member having an aperture disposed thereon. A plurality of concentric circular members are configured to removably secure within each other. The aperture is configured to removably secure the plurality of concentric circular members therein. In some embodiments, the plurality of concentric circular members are configured to removably secure within each other via friction fit. In another embodiment, the plurality of concentric circular members are configured to removably secure within the aperture via friction fit. In other embodiments, the aperture is disposed in the center of the planar member. In yet other embodiments, the irrigation pad further comprises at least one opening disposed along at least one edge of the planar member. In some embodiments, a plug is configured to removably secure within the opening. In another embodiment, the plug comprises a second plurality of concentric circular members configured to removably secure within each other. In other embodiments, the edge is linear. In yet other embodiments, the planar member comprises an octagonal perimeter. In some embodiments, the planar member comprises a durable material. In another embodiment, the planar member comprises vinyl.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the irrigation pad.

FIG. 2 shows an exploded view of an alternate embodiment of the irrigation pad.

FIG. 3 shows a close-up view of an embodiment of the irrigation pad in use.

FIG. 4 shows a perspective view of an embodiment of the irrigation pad in use.

### DETAILED DESCRIPTION OF THE INVENTION

Reference is made herein to the attached drawings. Like reference numerals are used throughout the drawings to depict like or similar elements of the irrigation pad. The figures are intended for representative purposes only and should not be considered to be limiting in any respect.

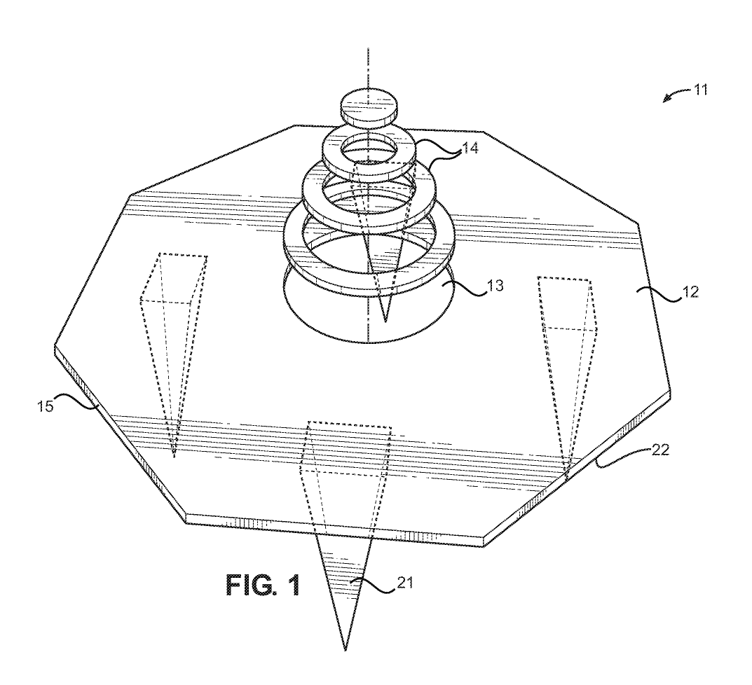

Referring now to FIG. 1, there is shown an exploded view of an embodiment of the irrigation pad. The irrigation pad 11 comprises a planar member 12 having an aperture 13 thereon. In the illustrated embodiment, the aperture 13 is disposed at the center of the planar member 12. The planar member 12 further comprises at least one edge 15. In some embodiments, the edge 15 is linear so as to provide the user the ability to abut the planar member 12 against a sidewalk or other flat surface. In the illustrated embodiment, the planar member 12 comprises an octagonal perimeter, however, in other embodiments, the planar member 12 comprises other shapes, such as circular or square.

The aperture 13 is adapted to fit a sprinkler head therethrough. A plurality of concentric circular members 14 removably secure within the aperture 13. The plurality of concentric circular members 14 also removably secure within each other. The plurality of concentric circular members 14 decrease in diameter in relation to their distance to the center of the aperture 13. As the distance from the center of the aperture 13 decreases, the diameter of the plurality of concentric circular members 14 decreases. In this way, the aperture 13 can accommodate a variety of different diameter sprinkler heads. Removing more of the concentric circular members 14 increases the diameter of the aperture 13. In some embodiments, the plurality of concentric circular members 14 are configured to removably secure within each other via a friction fit. In other embodiments, the plurality of concentric circular members 14 are configured to removably secure within the aperture 13 via a friction fit.

In some embodiments, the planar member 12 further comprises at least one fixation spike 21. The fixation spike 21 is affixed to a lower side 22 of the planar member 12. The fixation spike 21 serves to removably secure the planar member 12 to the ground, allowing the planar member 12 to remain in a fixed location. In other embodiments, the fixation spike 21 is removably securable to the planar member 12 via a fastener. Types of fasteners include, but are not limited to, hook and loop, screws, bolts, and the like.

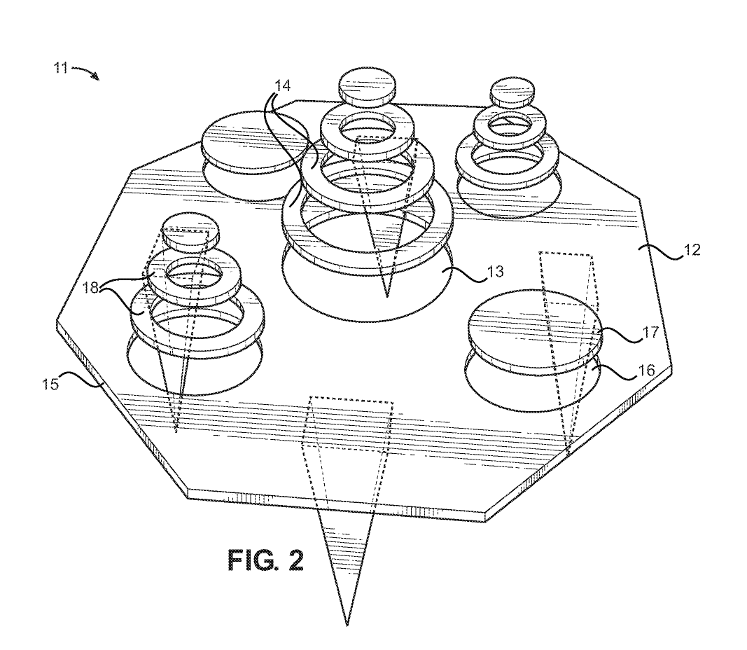

Referring now to FIG. 2, there is shown an exploded view of an alternate embodiment of the irrigation pad. In the illustrated embodiment, the planar member 12 comprises an aperture 13 and at least one opening 16 disposed at the edge 15. The opening 16 can comprise a variety of sizes to accommodate a variety of sprinkler heads. In the illustrated embodiment, several openings 16 are disposed along the edges 15 of the planar member 12. The openings 16 comprise different diameters to allow a user to select the appropriate size opening for their sprinkler head. The placement of the opening 16 at the edge 15 allows the irrigation pad 11 to be placed over a sprinkler head located in proximity to another object, such as a wall or sidewalk.

A plug 17 is configured to removably secure within the opening 16. In some embodiments, the plug 17 removably secures within the opening 16 via friction fit. In some embodiments, the plug 17 further comprises a second plurality of concentric circular members 18 adapted to removably secure within each other and the opening 16. In this way, the second plurality of concentric circular members 18 function similarly to the plurality of concentric circular members 14, as it allows the user to accommodate a variety of different sizes of sprinkler heads. In some embodiments, the second plurality of concentric circular members 18 are adapted to removably secure within each other via friction fit.

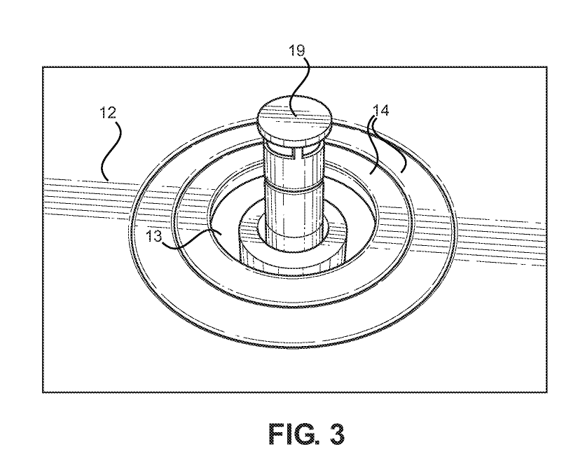

Referring now to FIG. 3, there is shown a close-up view of an embodiment of the irrigation pad in use. In the illustrated embodiment, a sprinkler head 19 is inserted through the aperture 13. The remainder of the plurality of concentric circular members 14 still removably secured within the aperture 13 provide a diameter through which the sprinkler head 19 fits. The user can adjust the size of the aperture 13 to fit a variety of sizes of sprinkler heads 19 while also keeping the area around the sprinkler head 19 uncovered by the planar member 12 as small as possible. This allows the user to minimize the interference of external forces on the sprinkler head's 19 operation, such as weeds or debris around the sprinkler head 19.

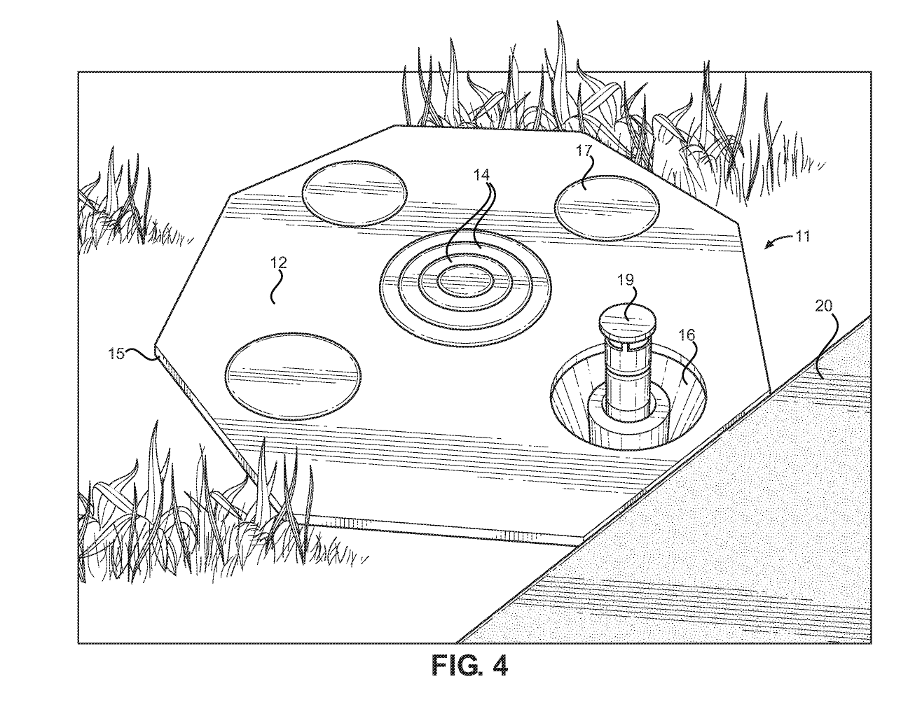

Referring now to FIG. 4, there is shown a perspective view of an embodiment of the irrigation pad in use. In the illustrated embodiment, the planar member 12 is placed over the area surrounding a sprinkler head 19. The sprinkler head 19 is disposed through the opening 16 disposed at the edge 15. In the illustrated embodiment, the edge 15 is linear to allow the planar member 12 to abut a sidewalk 20. In this way, a user can ensure the operation of a sprinkler head 19 placed in close proximity to an object, such as a sidewalk 20 or a wall.

Referring now to FIGS. 1-4, in one use, a user determines a sprinkler head 19 that they would like to ensure the unobstructed operation of. Depending on the location of the sprinkler head 19, the user determines whether to place the sprinkler head 19 through an opening 16 on an edge 15 or the aperture 13 disposed towards the center of the planar member 12. If the sprinkler head 19 is close to another object, such as a sidewalk 20, the user can insert the sprinkler head 19 through the opening 16 disposed at the edge 15 of the planar member 12. The plug 17 is then removed and the sprinkler head 19 placed through the opening 16. If the plug 17 comprises the second plurality of concentric circular members 18, the user removes the second plurality of concentric circular member 18 until the desired diameter of the opening 16 is achieved. The irrigation pad 11 is then placed over the sprinkler head 19. In some embodiments, the user can removably secure the irrigation pad 11 to the ground via the fixation spike 21 located on the lower side 22 of the planar member 12.

Likewise, if the sprinkler head 19 is located away from external obstacles, the user can decide to use the aperture 13 to protect a wider area surrounding the sprinkler head 19. In this use, the user would then remove the plurality of concentric circular members 14 until the desired diameter of the aperture 13 is achieved. The irrigation pad 11 is then placed over the sprinkler head 19 such that it is disposed within the aperture 13. In either use, the irrigation pad 11 prevents debris or weeds from accumulating around the sprinkler head 19, allowing it to operate unobstructed.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An irrigation pad, comprising:
a planar member having an aperture disposed thereon;
wherein an edge of the planar member is linear;
a plurality of concentric circular members adapted to removably secure within each other;
wherein the plurality of concentric circular members removably secure within the aperture.

2) The irrigation pad of claim 1, wherein the plurality of concentric circular members are adapted to removably secure within each other via friction fit.

3) The irrigation pad of claim 1, wherein the plurality of concentric circular member are configured to removably secure within the aperture via friction fit.

4) The irrigation pad of claim 1, wherein the aperture is disposed in the center of the planar member.

5) The irrigation pad of claim 1, further comprising at least one opening disposed along at least one edge of the planar member.

6) The irrigation pad of claim 5, further comprising a plug configured to removably secure within the opening.

7) The irrigation pad of claim 6, wherein the plug comprises a second plurality of concentric circular members configured to removably secure within each other.

8) The irrigation pad of claim 1, wherein the planar member comprises an octagonal perimeter.

9) The irrigation pad of claim 1, wherein the planar member comprises a durable material.

10) The irrigation pad of claim 9, wherein the planar member comprises vinyl.

11) The irrigation pad of claim 1, further comprising at least one fixation spike disposed on a lower side of the planar member configured to removably secure the planar member to a ground surface.

12) The irrigation pad of claim 11, wherein the fixation spike comprises a fastener thereon configured to removably secure the fixation spike to the lower side.
